(19) United States
(12) Patent Application Publication
(10) Pub. No.: US 2021/0208380 A1
(43) Pub. Date: Jul. 8, 2021

(54) DEVICE AND METHOD FOR HIGH-THROUGHPUT POLARIZATION IMAGING OF ZEBRAFISH

(71) Applicant: SUZHOU INSTITUTE OF BIOMEDICAL ENGINEERING AND TECHNOLOGY, CHINESE ACADEMY OF, Suzhou (CN)

(72) Inventors: HUI LI, SUZHOU (CN); GUANG YANG, SUZHOU (CN); XIN JIN, SUZHOU (CN); YONG LIANG, SUZHOU (CN); LINBO WANG, SUZHOU (CN)

(21) Appl. No.: 17/159,024

(22) Filed: Jan. 26, 2021

Related U.S. Application Data
(63) Continuation of application No. PCT/CN2018/107525, filed on Sep. 26, 2018.

(30) Foreign Application Priority Data
Jul. 26, 2018 (CN) 201810841066.1

(51) Int. Cl. G02B 21/36; G02B 21/08; G02B 21/00

(52) U.S. Cl. CPC G02B 21/367; G02B 21/0092; G02B 21/086

(57) ABSTRACT

The present application discloses a device and a method for high-throughput polarization imaging of zebrafish, comprising: a light source; a polarizing plate, comprising a first polarizing plate and a second polarizing plate having axes thereof coinciding with each other and connected with a rotating motor, the rotating motor drives the first polarizing plate and the second polarizing plate to rotate around the axes thereof respectively; a sample cell, wherein a glass capillary tube, which is arranged in a water bath in the sample cell, has freedom of rotation around its own axis; an injection pump, connected with the glass capillary tube through a hose; imaging equipment, comprising an objective lens, a cylindrical lens and a camera; the light source, first polarizing plate, sample cell, objective lens, second polarizing plate, cylindrical lens and camera are located on the same straight line and perpendicular to the glass capillary tube.

### CROSS REFERENCE TO RELATED APPLICATIONS

This application is a continuation of International Patent Application No. PCT/CN2018/107525 with a filing date of Sep. 26, 2018, designating the United States, now pending, and further claims priority to Chinese Patent Application No. 201810841066.1, filed on Jul. 26, 2018, the entire content of which is incorporated herein by reference.

### TECHNICAL FIELD

The present application relates to the field of optical experimental instruments, in particular to a device and a method for high-throughput polarization imaging of zebrafish.

### BACKGROUND

Zebrafish, as a common model animal, has important applications in genetic development research and drug screening. The muscle of normal wild zebrafish has birefringence effect, while zebrafish muscle with specific gene mutant has no birefringence effect. Therefore, it is suitable to conduct observation with a polarization microscope to distinguish between wild and mutant zebrafish samples.

In the phenotypic statistics of muscle mutation, polarization stereomicroscopes are generally used for observation. The basic steps include gel embedding and artificial phenotypic statistics under stereopolarizing microscope. The present application discloses a fully automatic polarization imaging device, which solves the problems of low automation degree and low efficiency of traditional polarization imaging of zebrafish.

In the statistical screening of zebra muscle phenotype, polarized light is used for observation and analysis, and the most commonly used method is to use polarized stereomicroscope for observation. This traditional method is not capable of carrying out high-throughput automatic statistics. Existing systems can only perform common bright-field imaging and confocal imaging, but have no polarization imaging capability. Existing polarization imaging technology is inefficient and cannot perform high-throughput imaging. The existing method for determining the attitude of the sample is bright field imaging, which obtains bright-field images with less distinctive characteristics, resulting in less accurate determination of the attitude. However, the polarization image features are obviously high in contrast, and the sample attitude can be determined more accurately according to a polarization image.

### SUMMARY

The problem to be solved by the present application is to provide a device and a method for high-throughput polarization imaging of zebrafish, which can realize high-throughput automatic statistics and accurately determine the attitude of a sample via polarization imaging.

To solve the above problems, the present application provides a device and a method for high-throughput polarization imaging of zebrafish. To achieve the above purpose, the technical solution adopted by the present application to solve the technical problems is as follows:

A device for high-throughput polarization imaging of zebrafish, comprising: a light source; a polarizing plate, comprising a first polarizing plate and a second polarizing plate having axes thereof coinciding with each other and connected with a rotating motor, the rotating motor drives the first polarizing plate and the second polarizing plate to rotate around the axes thereof respectively; a sample cell, wherein a glass capillary tube, which is arranged in a water bath in the sample cell, has freedom of rotation around its own axis; an injection pump, connected with the glass capillary tube through a hose; imaging equipment, comprising an objective lens, a cylindrical lens and a camera; wherein the light source, the first polarizing plate, the sample cell, the objective lens, the second polarizing plate, the cylindrical lens and the camera are sequentially located on the same straight line and perpendicular to the axis of the glass capillary tube.

The above technical solution brings the beneficial effects that, the objective lens is used for collecting image signals and imaging the surface of the object to infinity; the cylindrical lens is used to image the infinity signal to a target surface of the camera. The second polarizing plate is arranged behind the objective lens and close to a pupil surface of the objective lens, mainly for ensuring that the imaging light passes through the second polarizing plate as much as possible. Corporation of objective lens and cylindrical lens constitutes the basis of microscopic imaging, fully automatic sampling, imaging and statistics are adopted, and the attitude of the sample is calculated and adjusted. High-throughput polarization imaging can be performed, and the phenotypic distribution of samples can be counted by polarization imaging results. Specifically, high-throughput polarization imaging is realized through corporation of the rotating motor and a sample injection and ejection system; the attitude and orientation of zebrafish are determined according to polarization images of muscle; the two polarizing plates rotate in an orthogonal state all the time, and the glass capillary tube also performs self-rotation, so that the sample quickly passing through the glass capillary tube can be observed with high efficiency, while irrelevant variables can be controlled, and the whole automation degree is high.

As a further improvement to the present application, the sample cell is a cuboid with an opening at the top, with two sides thereof being transparent glass sheets, for light emitted by the light source to transmit through.

The above technical solution can deliver the beneficial effects that, the glass sheet is convenient for transmission of incident light, and the shape of the sample cell ensures that enough water can be accommodated.

As a further improvement to the present application, a condenser lens is arranged between the light source and the first polarizing plate.

The above technical solution can deliver the beneficial effects of focusing LED light on the surface of the sample.

As a further improvement to the present application, the glass capillary tube has an inner diameter of 0.8 mm, and an outer diameter of lmm.

The above technical solution delivers the beneficial effects of reducing the thickness of the tube, thereby reducing the influence of refraction by the glass capillary tube, as water and glass have different refractive indexes.

As a further improvement to the present application, the focal length of the cylindrical lens is 200 mm the objective lens is a quadruple objective lens, and the focal length of the condenser lens is 30 mm.

The above technical solution delivers the beneficial effect that, specifications of the cylindrical lens, objective lens and condenser lens can be selected to optimize the accuracy of the experiment and guarantee the imaging effect.

As a further improvement to the present application, the light source is a single crystal LED light source.

The above technical solution delivers the beneficial effect that, the single crystal LED light source has a small light emitting surface resulting in concentrated energy, which is convenient for focusing illumination light on the surface of the sample.

As a further improvement to the present application, the first polarizing plate and the second polarizing plate are always arranged orthogonally during synchronous rotation thereof, and are respectively connected with a first stepping motor and a second stepping motor; and the glass capillary tube is connected with a third stepping motor.

The above technical solution delivers the beneficial effect that, the stepping motor is convenient to control, facilitating accurate control of rotation over a specific angle.

As a further improvement to the present application, outer circumferential surfaces of the glass capillary tube, the first polarizing plate and the second polarizing plate are provided with a ring of gear teeth, and the first stepping motor, the second stepping motor and the third stepping motor are connected with gears which are externally engaged with the gear teeth.

The above technical solution delivers the beneficial effect that, the external meshing structure of the gear and the gear teeth are conducive to outputting the rotating motion of the stepping motors, and to converting the rotating motion of the motor into the rotating motion of the polarizing plate and the glass capillary tube.

As a further improvement to the present application, only one rotating motor is connected to the first polarizing plate or the second polarizing plate, and the first polarizing plate and the second polarizing plate are connected through a shaft rod, on which a first bevel gear is sleeved, the first bevel gear is externally tangent to a second bevel gear, axes of the first bevel gear and the second bevel gear are perpendicular to each other, a middle part of the second bevel gear is provided with a through hole, and the glass capillary tube and the hose are respectively coaxially fixed on shaft ends on two sides of the second bevel gear.

The above technical solution delivers the beneficial effect of reducing the number of the used rotating motors and cost, wherein one motor drives the first polarizing plate, the second polarizing plate and the glass capillary tube to rotate; meanwhile, the shaft rod does not interfere with the glass capillary tube, and the hose can easily bypass the shaft rod.

As a further improvement to the present application, the first polarizing plate, the second polarizing plate and the glass capillary tube are connected with a steering angle sensor which is connected with an electronic display screen.

The above technical solution delivers the beneficial effect that, the steering angle sensor can know the rotation angles of the first polarizing plate, the second polarizing plate and the glass capillary tube in real time, and the electronic display screen facilitates visual display of numerical values.

### BRIEF DESCRIPTION OF THE DRAWINGS

In order to make a clearer description of technical solutions in specific embodiments of the present invention or prior art, drawings involved in description for the specific embodiments or the prior art will be briefly introduced, and apparently, the drawings described below illustrate some embodiments of the present invention, for one with ordinary skill in the art, other drawings can also be obtained in accordance with these drawings without delivering creative efforts.

FIG. 1 is a structural schematic diagram of an embodiment of the present application;

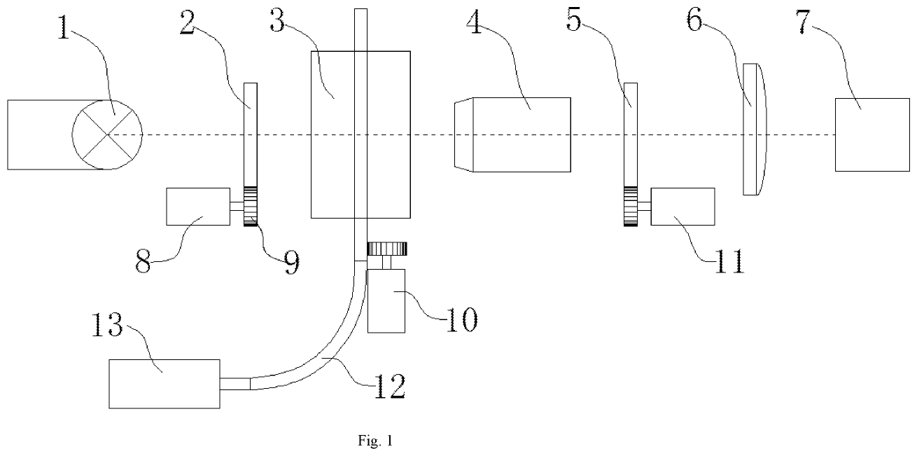

FIG. 2 is a partial perspective view of an embodiment of the present application;

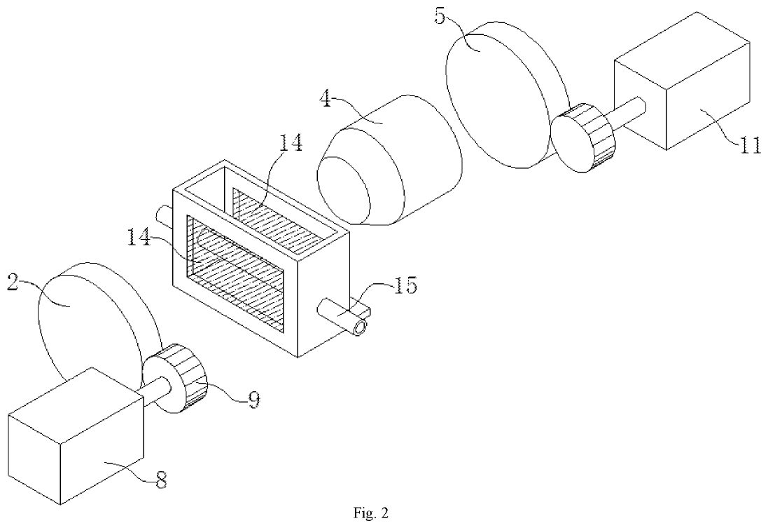

FIG. 3 is a flow chart of usage steps of an embodiment of the present application;

FIG. 4 is a structural schematic diagram of another embodiment of the present application;

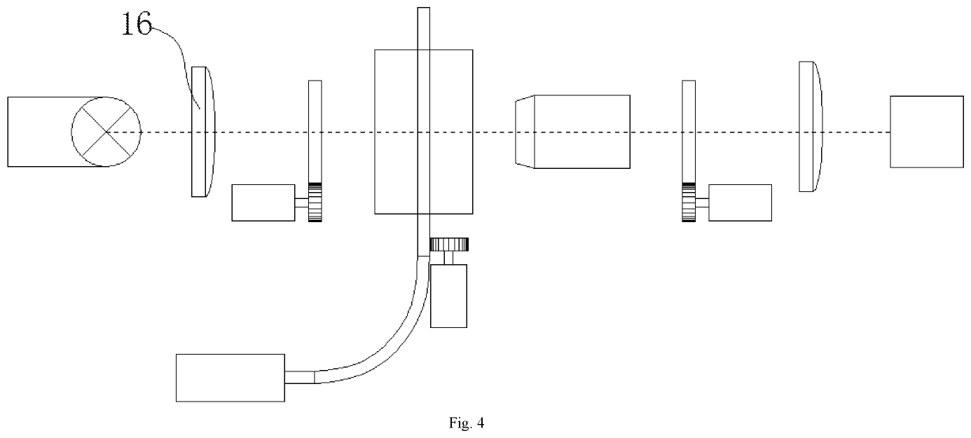

FIG. 5 is a partial perspective view of another embodiment of the present application.

1—light source; 2—the first polarizing plate; 3—sample cell; 4—objective lens; 5—Second polarizing plate; 6—cylindrical lens; 7—camera; 8—first stepping motor; 9—gear transmission mechanism; 10—third stepping motor; 11—second stepping motor; 12—hose; 13—injection pump; 14—glass sheet; 15—glass capillary tube; 16—condenser lens; 17—shaft rod; 18—first bevel gear; 19—second bevel gear.

### DETAILED DESCRIPTION

In the following, the contents of the present application will be further explained in detail with specific embodiments.

In order to achieve the purpose of the present application, a device for high-throughput polarization imaging of zebrafish is provided, comprising: a light source 1; a polarizing plate, comprising a first polarizing plate 2 and a second polarizing plate 5 having axes thereof coinciding with each other and connected with a rotating motor, which drives the first polarizing plate 2 and the second polarizing plate 5 to rotate around an axis thereof respectively; a sample cell 3, wherein a glass capillary tube 15, which is arranged in a water bath in the sample cell 3, has freedom of rotation around an axis thereof; an injection pump 13, connected with the glass capillary tube 15 through a hose 12; imaging equipment, comprising an objective lens 4, a cylindrical lens 6 and a camera 7; wherein the light source 1, the first polarizing plate 2, the sample cell 3, the objective lens 4, the second polarizing plate 5, the cylindrical lens 6 and the camera 7 are sequentially located on the same straight line and perpendicular to the axis of the glass capillary tube 15.

The above technical solution delivers the beneficial effects that, the objective lens is used for collecting image signals and imaging the surface of the object to infinity; the cylindrical lens is used to image the infinity signal to a target surface of the camera. The second polarizing plate is arranged behind the objective lens and close to a pupil surface of the objective lens, mainly for ensuring that the imaging light passes through the second polarizing plate as much as possible. Corporation of the objective lens and the cylindrical lens constitutes the basis of microscopic imaging, fully automatic sampling, imaging and statistics are adopted, and the attitude of the sample is calculated and adjusted. High-throughput polarization imaging can be performed, and the phenotypic distribution of samples can be counted by polarization imaging results. Specifically, high-throughput polarization imaging is realized through corporation of the rotating motor and a sample injection and ejection system; the attitude and orientation of zebrafish are determined according to polarization images of muscle; the two polarizing plates rotate in an orthogonal state all the time, and the glass capillary tube also performs self-rotation, so that the sample quickly passing through the glass capillary tube can be observed with high efficiency, while irrelevant variables can be controlled, and the whole automation degree is high.

In other embodiments of the present application, the sample cell 3 is a cuboid with an opening at the top, with two sides thereof being transparent glass sheets 14, for light emitted by the light source 1 to transmit through.

The above technical solution delivers the beneficial effect that, the glass sheet is convenient for transmission of incident light, and the shape of the sample cell ensures that enough water can be accommodated.

In other embodiments of the present application, a condenser lens 16 is provided between the light source 1 and the first polarizing plate 2.

The above technical solution delivers the beneficial effect of focusing LED light on the surface of the sample.

In other embodiments of the present application, the glass capillary tube 15 has an inner diameter of 0.8 mm and an outer diameter of 1 mm.

The above technical solution delivers the beneficial effect of reducing the thickness of the tube, thereby reducing the influence of refraction by the glass capillary tube, as water and glass have different refractive indexes.

In other embodiments of the present application, the focal length of the cylindrical lens 6 is 200 mm, the objective lens 4 is a quadruple objective lens, and the focal length of the condenser lens 16 is 30 mm.

The flow rate of the injection pump 13 is 100 ul/min. The first polarizing plate 2, the second polarizing plate 5 rotate over an angle of 10° one time, and the glass capillary tube rotates over an angle of 10° or 5° one time.

The above technical solution delivers the beneficial effect that, specifications of the cylindrical lens, objective lens and condenser lens can be selected to optimize the accuracy of the experiment and guarantee the imaging effect.

In other embodiments of the present application, the light source 1 is a single crystal LED light source.

The above technical solution delivers the beneficial effect that, the single crystal LED light source has a small light emitting surface resulting in concentrated energy, which is convenient for focusing illumination light on the surface of the sample.

In other embodiments of the present application, the first polarizing plate 2 and the second polarizing plate 5 are always arranged orthogonally during synchronous rotation thereof, and are respectively connected with a first stepping motor 8 and a second stepping motor 11; and the glass capillary tube 15 is connected with a third stepping motor 10.

The above technical solution brings the beneficial effect that, the stepping motor is convenient to control, facilitating accurate control of rotation over a specific angle.

In other embodiments of the present application, the outer circumferential surfaces of the glass capillary tube 15, the first polarizing plate 2 and the second polarizing plate 5 are provided with a ring of gear teeth, and the first stepping motor 8, the second stepping motor 11 and the third stepping motor 10 are connected with gears which are externally engaged with the gear teeth.

The above technical solution brings the beneficial effect that, the external meshing structure of the gear and the gear teeth are conducive to outputting the rotating motion of the stepping motors, and to converting the rotating motion of the motor into the rotating motion of the polarizing plate and the glass capillary tube.

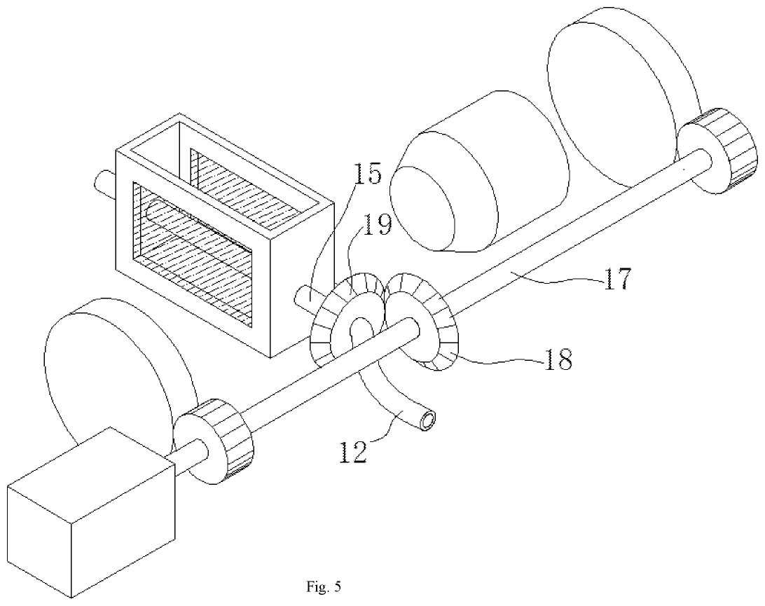

In other embodiments of the present application, as shown in FIG. 5, only one rotating motor is connected to the first polarizing plate 2 or the second polarizing plate 5, and the first polarizing plate 2 and the second polarizing plate 5 are connected through a shaft rod 17, on which a first bevel gear 18 is sleeved, the first bevel gear 18 is externally tangent to a second bevel gear 19, axes of the first bevel gear 18 and the second bevel gear 19 are perpendicular to each other, a middle part of the second bevel gear 19 is provided with a through hole, and the glass capillary tube 15 and the hose 12 are respectively coaxially fixed on shaft ends on two sides of the second bevel gear 19.

The above technical solution delivers the beneficial effect of reducing the number of the used rotating motors and cost, wherein one motor drives the first polarizing plate, the second polarizing plate and the glass capillary tube to rotate; meanwhile, the shaft rod does not interfere with the glass capillary tube, and the hose can easily bypass the shaft rod.

In other embodiments of the present application, the first polarizing plate 2, the second polarizing plate 5 and the glass capillary tube 15 are connected with a steering angle sensor which is connected with an electronic display screen.

The above technical solution brings the beneficial effect that, the steering angle sensor can know the rotation angles of the first polarizing plate, the second polarizing plate and the glass capillary tube in real time, and the electronic display screen facilitates visual display of numerical values.

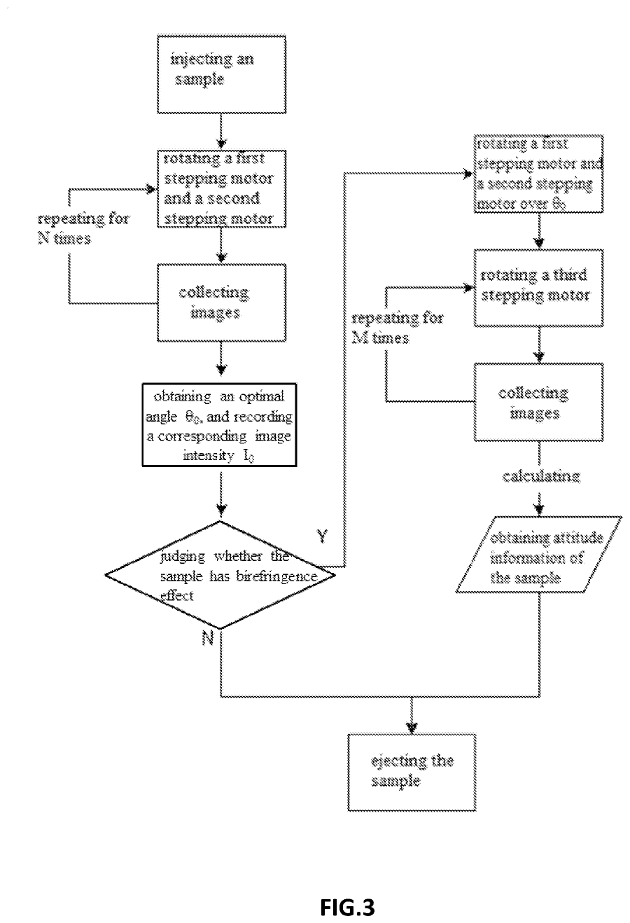

As shown in FIG. 3:

step 1, sample injection: driving a sample into a glass capillary tube 15 by an injection pump 13;

step 2: rotating the first polarizing plate 2 and the second polarizing plate 5, and driving the two polarizing plates to rotate over the same angle 60 through a first stepping motor 8 and a second stepping motor 11;

step 3: collecting images, i.e., collecting polarized images by a camera;

repeating step 2 and step 3 for N times, where N*60=180°;

step 4: selecting an image with the strongest image signal among N polarized images, and recording a corresponding angle θ₀;

step 5: obtaining polarization characteristics of the sample according to intensity information of the image with the strongest image signal, and judging whether the sample has birefringence effect; judging whether a muscle phenotype of the sample of zebrafish muscle undergoes mutation, under the condition of whether the image intensity exceeds a certain threshold T, if it does, the sample is wild typed, otherwise the sample has no birefringence effect and is mutation typed, then ejecting the sample; or entering the next step if the sample has birefringence effect;

step 6: rotating the first polarizing plate 2 and the second polarizing plate 5 to an angle of θ₀ by the first stepping motor 8 and the second stepping motor 11;

step 7: rotating the glass capillary tube 15, i.e., driving the glass capillary tube 15 to rotate over an angle of δφ through a third stepping motor 10;

step 8: collecting images, i.e., collecting the polarized images by the camera 7;

repeating step 7 and step 8 for M times, where M*δφ=360°;

step 9: calculating sample attitude information according to the polarization characteristics

The axial attitude of the sample is determined by rotation of the glass capillary tube 15, analysis of the polarized image, and utilization of the high contrast of zebrafish muscle in the polarized image. The importance of determining the attitude of the sample is that the sample can be directly adjusted according to the angle of interest during microscopic observation, so that areas of interest can enter the field of view.

Compared with bright-field images, polarized images have higher contrast in muscle parts and distinctive features among different attitudes. For zebrafish, two pieces of muscles can be seen from the back, corresponding to two bright bands, while only one piece of muscle can be seen from the side, hence only one bright band is displayed in the corresponding image. This patent makes use of the distinctive muscle characteristics in the polarized image, so as to conveniently determine the attitude of the sample.

The above embodiments are only intended for describing the technical concept and features of the present application, and aimed at enabling those skilled in the art to understand and implement the contents of the present application, rather than limiting the protection scope thereof. All equivalent changes or modifications made according to the spirit of the present application shall fall into the protection scope thereof.

What is claimed is:

1. A device for high-throughput polarization imaging of zebrafish, comprising:
a light source;
a polarizing plate, comprising a first polarizing plate and a second polarizing plate having axes thereof coinciding with each other and connected with a rotating motor, which drives the first polarizing plate and the second polarizing plate to rotate around an axis thereof respectively;
a sample cell, wherein a glass capillary tube, which is arranged in a water bath in the sample cell, has freedom of rotation around an axis thereof;
an injection pump, connected with the glass capillary tube through a hose;
imaging equipment, comprising an objective lens, a cylindrical lens and a camera;
wherein the light source, the first polarizing plate, the sample cell, the objective lens, the second polarizing plate, the cylindrical lens and the camera are sequentially located on the same straight line and perpendicular to an axis of the glass capillary tube.

2. The device for high-throughput polarization imaging of zebrafish of claim 1, wherein, the sample cell is a cuboid with an opening at the top, with two sides thereof being transparent glass sheets, for light emitted by the light source to transmit through.

3. The device for high-throughput polarization imaging of zebrafish of claim 1, wherein, a condenser lens is arranged between the light source and the first polarizing plate, and a focal distance of the condenser lens is 30 mm.

4. The device for high-throughput polarization imaging of zebrafish of claim 1, wherein, the glass capillary tube has an inner diameter of 0.8 mm and an outer diameter of 1 mm, the focal length of the cylindrical lens is 200 mm and the objective lens is a quadruple objective lens.

5. The device for high-throughput polarization imaging of zebrafish of claim 1, wherein, the light source is a single crystal LED light source.

6. The device for high-throughput polarization imaging of zebrafish of claim 1, wherein, the first polarizing plate and the second polarizing plate are always arranged orthogonally during synchronous rotation thereof, and are respectively connected with a first stepping motor and a second stepping motor; and the glass capillary tube is connected with a third stepping motor.

7. The device for high-throughput polarization imaging of zebrafish of claim 6, wherein, outer circumferential surfaces of the glass capillary tube, the first polarizing plate and the second polarizing plate are provided with a ring of gear teeth, and the first stepping motor, the second stepping motor and the third stepping motor are connected with gears which are externally engaged with the gear teeth.

8. The device for high-throughput polarization imaging of zebrafish of claim 1, wherein, only one rotating motor is connected to the first polarizing plate or the second polarizing plate, and the first polarizing plate and the second polarizing plate are connected through a shaft rod, on which a first bevel gear is sleeved, the first bevel gear is externally tangent to a second bevel gear, axes of the first bevel gear and the second bevel gear are perpendicular to each other, a middle part of the second bevel gear is provided with a through hole, and the glass capillary tube and the hose are respectively coaxially fixed on shaft ends on two sides of the second bevel gear; and the first polarizing plate, the second polarizing plate and the glass capillary tube are connected with a steering angle sensor which is connected with an electronic display screen.

9. A method for high-throughput polarization imaging of zebrafish, comprising:
step 1, injecting an sample: driving a sample into a glass capillary tube by an injection pump;
step 2: rotating the first polarizing plate and the second polarizing plate, and driving the two polarizing plates to rotate over the same angle δθ through a first stepping motor and a second stepping motor;
step 3: collecting images, i.e., collecting polarized images by a camera;
repeating step 2 and step 3 for N times, where N*δθ=180°;
step 4: selecting an image with the strongest image signal among N polarized images, and recording a corresponding angle θ₀;
step 5: obtaining polarization characteristics of the sample according to intensity information of the image with the strongest image signal, and judging whether the sample has birefringence effect; judging whether a muscle phenotype of the sample of zebrafish muscle undergoes mutation, under the condition of whether the image intensity exceeds a certain threshold T, if the image intensity exceeds a certain threshold T, the sample is wild typed, otherwise the sample has no birefringence effect and is mutation typed, then ejecting the sample; or entering the next step if the sample has birefringence effect;
step 6: rotating the first polarizing plate and the second polarizing plate to an angle of θ₀ by the first stepping motor and the second stepping motor;
step 7: rotating the glass capillary tube, i.e., driving the glass capillary tube to rotate over an angle of δφ through a third stepping motor;
step 8: collecting images, i.e., collecting the polarized images by the camera;
repeating step 7 and step 8 for M times, where M*δφ=360°;
step 9: calculating sample attitude information according to the polarization characteristics.

10. The method for high-throughput polarization imaging of zebrafish according to claim 9, wherein, δθ has an angle of 10°, and δφ has an angle of 10° or 5°.
